(19) United States
(12) Patent Application Publication
(10) Pub. No.: US 2008/0106108 A1
(43) Pub. Date: May 8, 2008

(54) ANIMAL LITTER COLLECTOR

(75) Inventor: Tung Yan Lau, N.T. (HK)

Correspondence Address: Eric Chan, 42 Pin Oaks Drive, Phoenixville, PA, 19460, US

(73) Assignee: Design Manufacture Limited, N.T. (HK)

(21) Appl. No.: 11/556,709

(22) Filed: Nov. 6, 2006

(51) Int. Cl. A01K 29/00

(52) U.S. Cl. 294/1.3

(57) ABSTRACT

The present invention relates to an animal litter collector which comprises a receptacle which is in thin, flat and elongated shape having a blade portion at one end and a handle portion extending from the blade portion with a handle formed at the other end, and the handle portion has an elongated opening underneath the handle having a mounting member disposed across the opening dividing it into the upper opening and the lower opening; and a fastener which is in thin and elongated shape with its width shorter than the width of the opening and the width of the mounting member, and it can be folded into halves with the attaching end removably secured onto the mounting member and the two loosening flaps at the other end removably secured together in the lower opening. This invention is disposable, portable, susceptible of a low cost of manufacture and an affordable price of sale, and convenient for use and can effectively pick up and hold the litter for disposal as a whole.

### BACKGROUND OF THE INVENTION

The present invention relates to an animal litter collector and more particularly pertains to a disposable animal litter collector for picking up and holding the litter for disposal as a whole after each use.

In many jurisdictions, pet owners are statutorily required to collect the animal litter as soon as it is deposited on streets in city areas. To avoid penalty of fines, pet owners are generally willing to collect and dispose of litter created by their pets in public areas. For sanitary purposes and aesthetic considerations, pet owners also need to clean up litter in their own private areas. These needs are particularly notorious for dog owners living in the cities as it is common to take the dogs out for a walk everyday in the public areas such as sidewalks, parks or even beaches. The most basic article that a dog owner has to bring along is a plastic bag which the dog owner can use to pick up the dog's feces. Though the dog owner's hands may not touch the feces directly, most dog owners find the act disgusting. Some dog owners use small implements such as small shovels, but unless these implements are disposable, subsequent cleaning up of the implements remains to be distasteful.

There are a number of disposable articles or devices to assist dog owners to clean up after their dogs. Most of them require complicated assembly or folding before use. Some of them have handles or supporting stands, and it is inconvenient to carry them around while walking the dogs. All of existing disposable articles or devices have bags or boxes of pre-determined size attached to them, but different dogs' feces are different in volume and it is a waste of resources to provide such standardized bags or boxes. These disposable articles or devices are not that popular among dog owners because in general the articles or devices are relatively complex in construction and susceptible of high costs of manufacture, which accordingly susceptible of high prices of sale, thereby making such articles or devices economically unaffordable to the dog owners.

### BRIEF SUMMARY OF THE INVENTION

In view of the aforesaid disadvantages now present in the prior art, the object of the present invention is to provide an animal litter collector which is disposable, portable, susceptible of a low cost of manufacture and an affordable price of sale, and convenient for use and can effectively pick up and hold the litter for disposal as a whole.

To attain this, the present invention generally comprises a receptacle which is in thin, flat and elongated shape having a blade portion at one end and a handle portion extending from the blade portion with a handle formed at the other end, and the handle portion has an elongated opening underneath the handle having a mounting member disposed across the opening dividing it into the upper opening and the lower opening; and a fastener which is in thin and elongated shape with its width shorter than the width of the opening and the width of the mounting member, and it can be folded into halves with the attaching end removably secured onto the mounting member and the two loosening flaps at the other end removably secured together in the lower opening.

The fastener is made of plastics or rubber and so it is flexible and easy to use. Since it is small in size, though it cannot recycled, its negative impact on the environment is minimized.

The receptacle is made of thick paper or cardboard paper and so it can be decomposed entirely. The receptacle can be made of any other material such as plastics.

The attaching end of the fastener has one or more protruding members on one side and a corresponding number of holes on the other side and the mounting member also has a corresponding number of holes such that the protruding members on one side of the attaching end can removably insert into the holes of the mounting member and then into the holes on the other side of the attaching end, thereby the attaching end is removably secured onto the mounting member.

One of the two loosening flaps has one or more protruding members and the other loosening flap has a corresponding number of holes such that the protruding members can removably insert into the holes, thereby the two loosening flaps are removably secured together.

The attaching end is removably secured onto the mounting member such that the two loosening flaps at the other end are originally pointing upwards facing the handle, and each of the loosening flaps can then be folded outside downwards and removably secured together in the lower opening.

The receptacle is embossed with two folding lines one being an outward concave line running from the top edge of the handle portion through the lower right corner of the lower opening to the lower right corner of the blade portion and the other being an outward concave line running from the top edge of the handle portion through the lower left corner of the lower opening to the lower left corner of the blade portion. The user can fold the blade portion of the receptacle along two folding lines, thereby making it into a shape of shovel for ease of picking up the feces.

The receptacle is embossed with a middle folding line roughly separating the blade portion and the handle portion. The receptacle can be folded along the middle folding line in half for ease of packaging, storage and transportation before selling to the users and for ease of being carried around by the users while walking their dogs.

The animal litter collector further comprises a bag made of paper or plastics with one side being open whose width is larger than the width of the receptacle, and the two loosening flaps can be secured together in the lower opening with the open side of the bag being secured in between. As the open side of the bag is secured by the two loosening flaps, this can effectively prevent the feces inside the bag from coming out of the bag. For saving in costs and better utilization of resources, it is recommendable to use reused bags. If new bags are to be used, bags made of paper will be recommendable as they can be decomposed entirely.

The bag may have through holes near the open side and the two loosening flaps can be secured together through the through holes in the lower opening with the open side of the bag being secured in between, thereby preventing the feces inside the bag from coming out of the bag. The through holes of the bag facilitate the ease of piercing the protruding members of the loosening flaps through the open side of the bag.

The bottom edge of the blade portion of the receptacle has ragged notches, teeth or points along the edge for ease of picking up the feces.

The blade portion of the receptacle has a plurality of perforated holes which allows any sandy particles or grass picked up to be fallen back onto the sandy ground or turf.

To use the present invention, the user can first unfold the receptacle if it is folded in half and then mount the attaching end of the fastener onto the mounting member of the receptacle. Alternatively, the manufacturer may mount the attaching end of the fastener onto the mounting member of the receptacle first before the finished product is sold. The user may fold the blade portion of the receptacle along two folding lines, thereby making it into a shape of shovel for ease of picking up the feces. The user then holds the handle portion of the receptacle and uses the blade portion of the receptacle to pick up the feces. The ragged notches, teeth or points along the bottom edge of the blade portion of the receptacle increase the ease of picking up the feces. The plurality of perforated holes of the blade portion of the receptacle allows the sandy particles and grass picked up to be fallen back onto the sandy ground or turf. The user then puts the blade portion with the feces on it into the bag, which may be any re-used bag for being environmentally friendly. The user then folds the two loosening flaps outside downwards and by means of inserting the protruding members into the holes of the two loosening flaps with the open side of the bag being pierced through by the protruding members, thereby securing the open side of the bag in between and preventing the feces inside the bag from coming out of the bag. The user can then dispose of the whole thing in the nearest rubbish bin or feces collection box.

In comparison with the prior art, the present invention has the following advantages and effects:

First, since the animal litter collector of the present invention is of simple construction with a thin, flat and elongated receptacle and a thin and elongated fastener, it can be portable and susceptible of a low cost of manufacture and an affordable price of sale. Owing to these, the present invention can be disposable and convenient for use.

Secondly, the receptacle has a middle folding line which makes it easier to be folded into halves for ease of packaging, storage, transportation and being carried around. The receptacle also has two folding lines which make it easier to be folded into a shape of shovel for ease of picking up and holding of the litter for disposal.

Finally, only the fastener of the present invention is made of plastic or rubber and which is relatively small in size. Further, the present invention can use any re-used bag or the paper bag as provided. This construction is more environmentally friendly as the receptacle and the bag if made of paper can be decomposed entirely.

### BRIEF DESCRIPTION OF THE DRAWINGS

FIG. 1 shows a perspective view of the receptacle of the present invention.

FIG. 2 shows a perspective view of the fastener of the present invention.

FIG. 3 shows a view of the receptacle with the fastener of the present invention.

FIG. 4 shows another view of the receptacle with the fastener.

FIG. 5 shows a further view of the receptacle with the fastener.

FIG. 6 shows an enlarged cross-sectional view of the fastener as in FIG. 5.

FIG. 7 shows a bottom view of FIG. 5 while the loosening flaps of the fastener in the receptacle are being flapped down.

FIG. 8 shows a bottom view of FIG. 5 while the loosening flaps of the fastener in the lower opening of the receptacle are being secured together.

FIG. 9 shows a bottom view of FIG. 5 while the loosening flaps of the fastener in the lower opening of the receptacle are being secured together with the bag being secured in between.

FIG. 10 shows a view of another embodiment of the receptacle with the fastener of the present invention.

### DETAILED DESCRIPTION OF THE INVENTION

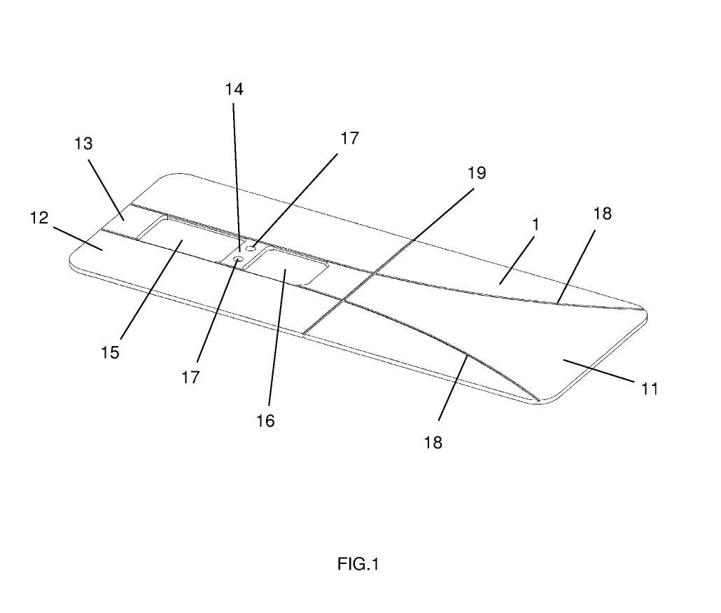

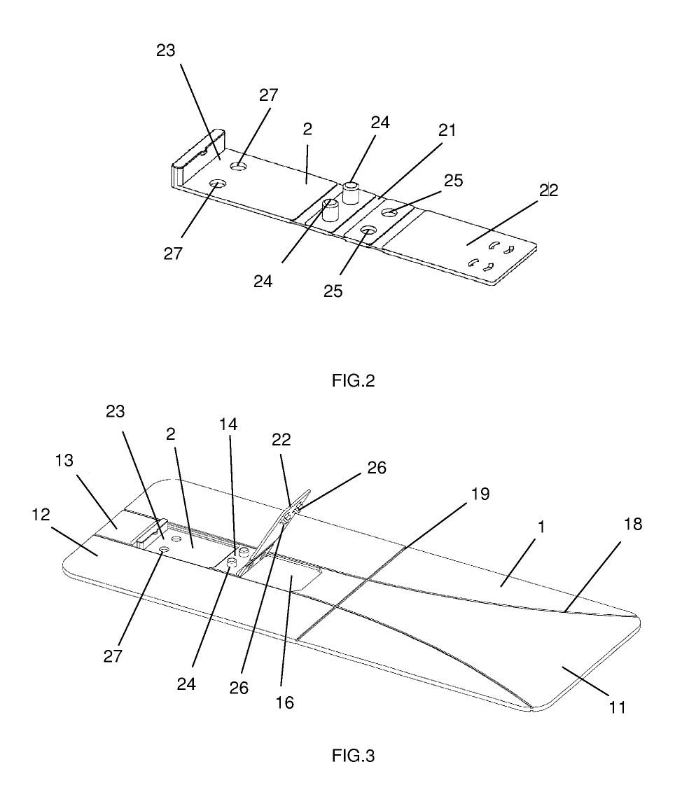

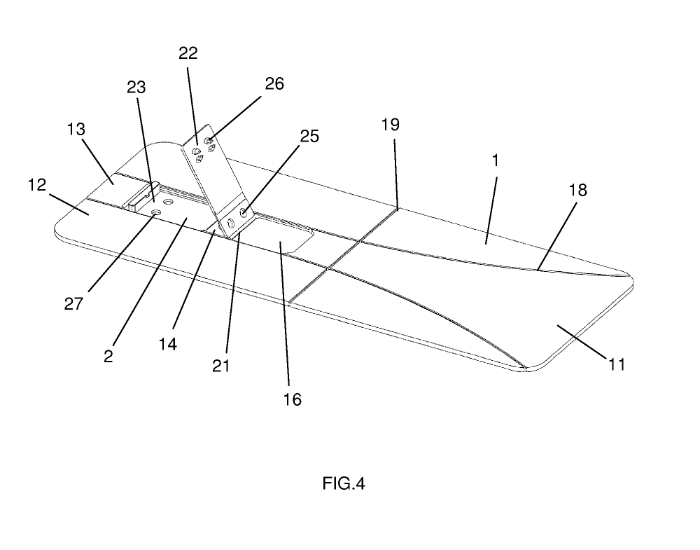

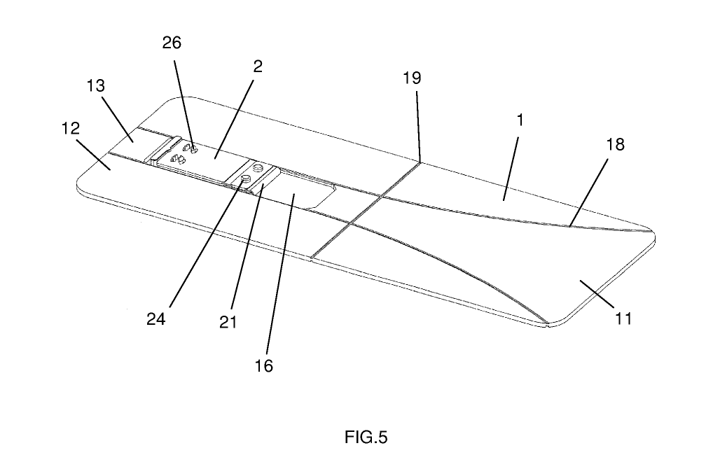

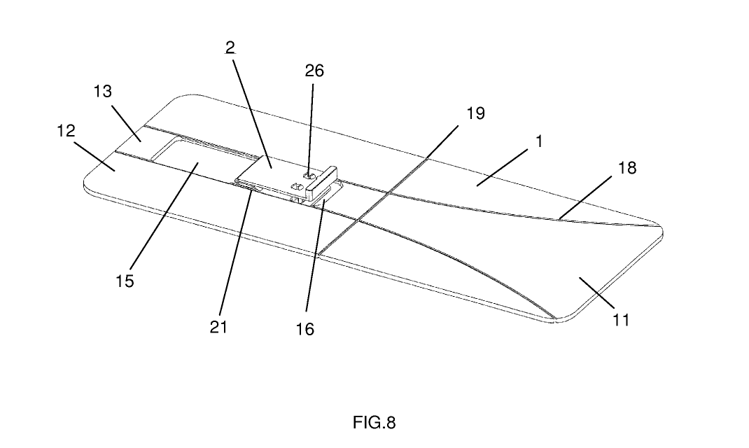

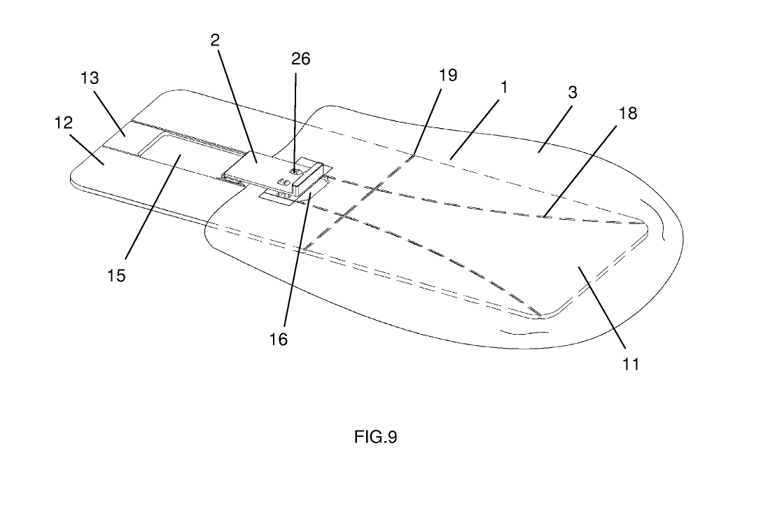

The present invention is further described in detail with the following embodiments and the accompanying drawings. FIGS. 1 to 9 illustrate an embodiment of this animal litter collector of the present invention. As illustrated in FIGS. 1 and 2, the animal litter collector comprises a receptacle 1 which is made of thick paper or cardboard paper in thin, flat and elongated shape having a blade portion 11 at one end and a handle portion 12 extending from the blade portion 11 with a handle 13 formed at the other end, and the handle portion 12 has an elongated opening underneath the handle 12 having a mounting member 14 disposed across the opening dividing it into the upper opening 15 and the lower opening 16; and a fastener 2 which is made of plastics in this embodiment, or rubber in other embodiments, in thin and elongated shape with its width shorter than the width of the opening and the width of the mounting member 14, and it can be folded into halves with the attaching end 21 removably secured onto the mounting member 14 and the two loosening flaps 22, 23 at the other end removably secured together in the lower opening 16. In this embodiment, the receptacle 1 is embossed with two folding lines 18 one being an outward concave line running from the top edge of the handle portion 12 through the lower right corner of the lower opening 16 to the lower right corner of the blade portion 11 and the other being an outward concave line running from the top edge of the handle portion 12 through the lower left corner of the lower opening 16 to the lower left corner of the blade portion 11. The user can fold the blade portion 11 of the receptacle 1 along two folding lines 18, thereby making it into a shape of shovel for ease of picking up the feces. The receptacle 1 is also embossed with a middle folding line 19 roughly separating the blade portion 11 and the handle portion 12. The receptacle 1 can then be folded along the middle folding line 19 into halves for ease of packaging, storage and transportation before selling to the users and for ease of being carried around by the users while walking their dogs.

As illustrated in FIGS. 2 and 9, the attaching end 21 of the fastener 2 has two protruding members 24 on one side and two corresponding holes 25 on the other side and the mounting member 14 also has two corresponding holes 17 such that the protruding members 24 on one side of the attaching end 21 can removably insert into the holes 17 of the mounting member 14 and then into the holes 25 on the other side of the attaching end 21, thereby the attaching end 21 is removably secured onto the mounting member 14. In other embodiments, there can be one or more protruding members on one side of the attaching end of the fastener and a corresponding number of holes on the other side and the mounting member.

Further, as illustrated in FIGS. 3 to 6, one of the two loosening flaps 22 has two protruding members 26 and the other loosening flap 23 has two corresponding holes 27 such that the protruding members 26 can removably insert into the holes 27, thereby the two loosening flaps 22, 23 are removably secured together.

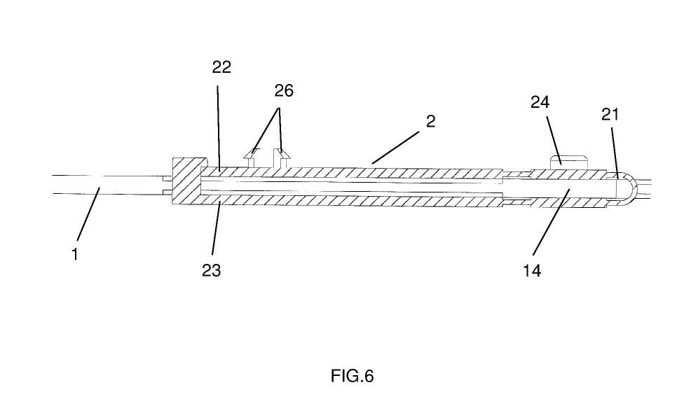

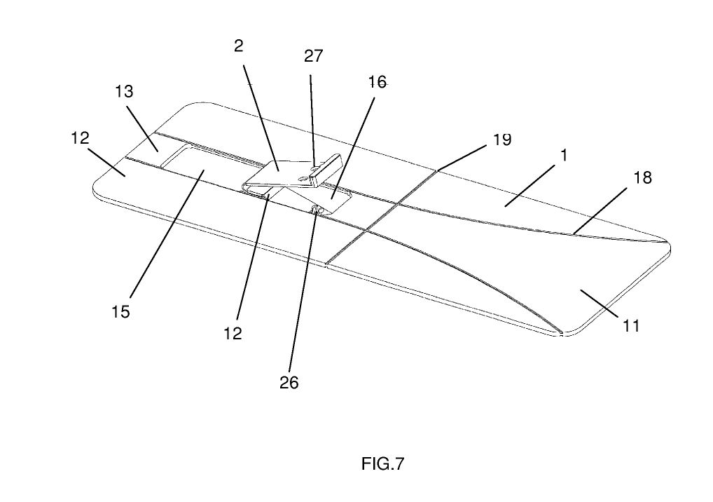

The attaching end 21 is removably secured onto the mounting member 14 such that the two loosening flaps 22, 23 at the other end are originally pointing upwards facing the handle 13 as illustrated in FIGS. 5 and 6, and each of the loosening flaps 22, 23 can then be folded outside downwards and removably secured together in the lower opening 16 as illustrated in FIGS. 7 to 9.

As illustrated in FIG. 9, the animal litter collector further comprises a bag 3 made of paper with one side being open whose width is larger than the width of the receptacle 1, and the two loosening flaps 22, 23 can be secured together in the lower opening 16 with the open side of the bag 3 being secured in between. As the open side of the bag 3 is secured by the two loosening flaps 22, 23, this can effectively prevent the feces inside the bag 3 from coming out of the bag 3. For saving in costs and better utilization of resources, it is recommendable to use reused bags. In other embodiments, the bag may be made of plastics. Not shown in the drawings, the bag may have through holes near the open side and the two loosening flaps 22, 23 can be secured together through the through holes in the lower opening 16 with the open side of the bag 3 being secured in between, thereby preventing the feces inside the bag 3 from coming out of the bag 3.

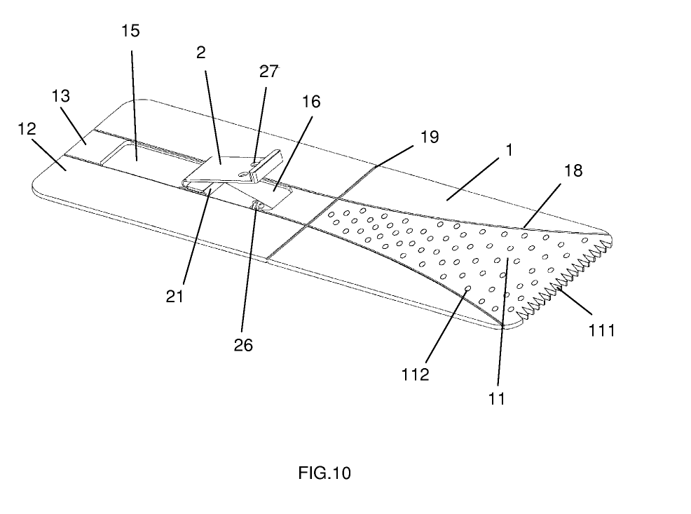

As illustrated in FIG. 10, the bottom edge 111 of the blade portion 11 of the receptacle 1 has ragged teeth along the edge for ease of picking up the feces. In other embodiments, the ragged teeth can be ragged notches or points. In addition, the blade portion 11 of the receptacle 1 has a plurality of perforated holes 112 which allows any sandy particles or grass picked up to be fallen back onto the sandy ground or turf.

To use the animal litter collector, the user can first unfold the receptacle 1 if it is folded in half and then mount the attaching end 21 of the fastener 2 onto the mounting member 14 of the receptacle 1. Alternatively, the manufacturer may mount the attaching end 21 of the fastener 2 onto the mounting member 14 of the receptacle 1 first as illustrated in FIGS. 5 and 6 before the finished product is sold. The user may fold the blade portion 11 of the receptacle 1 along two folding lines 18, thereby making it into a shape of shovel for ease of picking up the feces. The user then holds the handle portion 12 of the receptacle 1 and uses the blade portion 11 of the receptacle 1 to pick up the feces. If there are the ragged teeth along the bottom edge 111 of the blade portion 11 of the receptacle 1 and the plurality of perforated holes 112 as illustrated in FIG. 10, the ragged teeth will increase the ease of picking up the feces, and the plurality of perforated holes 112 will allow the sandy particles and grass picked up to be fallen back onto the sandy ground or turf. The user then puts the blade portion 11 with the feces on it into the bag, which may be any re-used bag for being environmentally friendly. The user then folds the two loosening flaps 22, 23 outside downwards and by means of inserting the protruding members 26 into the holes 27 of the two loosening flaps 22, 23 with the open side of the bag 3 being pierced through by the protruding members 26, thereby securing the open side of the bag 3 in between and preventing the feces inside the bag 3 from coming out of the bag 3. The user can then dispose of the whole thing in the nearest rubbish bin or feces collection box.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. An animal litter collector, comprising:
a receptacle which is in thin, flat and elongated shape having a blade portion at one end and a handle portion extending from the blade portion with a handle formed at the other end, and the handle portion has an elongated opening underneath the handle having a mounting member disposed across the opening dividing it into the upper opening and the lower opening; and
a fastener which is in thin and elongated shape with its width shorter than the width of the opening and the width of the mounting member, and it can be folded into halves with the attaching end removably secured onto the mounting member and the two loosening flaps at the other end removably secured together in the lower opening.

2. The animal litter collector as in claim 1, wherein the attaching end of the fastener has one or more protruding members on one side and a corresponding number of holes on the other side and the mounting member also has a corresponding number of holes such that the protruding members on one side of the attaching end can removably insert into the holes of the mounting member and then into the holes on the other side of the attaching end, thereby the attaching end is removably secured onto the mounting member.

3. The animal litter collector as in claim 1, wherein one of the two loosening flaps has one or more protruding members and the other loosening flap has a corresponding number of holes such that the protruding members can removably insert into the holes, thereby the two loosening flaps are removably secured together.

4. The animal litter collector as in claim 1, wherein the attaching end is removably secured onto the mounting member such that the two loosening flaps at the other end are originally pointing upwards facing the handle, and each of the loosening flaps can then be folded outside downwards and removably secured together in the lower opening.

5. The animal litter collector as in claim 2, wherein the attaching end is removably secured onto the mounting member such that the two loosening flaps at the other end are originally pointing upwards facing the handle, and each of the loosening flaps can then be folded outside downwards and removably secured together in the lower opening.

6. The animal litter collector as in claim 3, wherein the attaching end is removably secured onto the mounting member such that the two loosening flaps at the other end are originally pointing upwards facing the handle, and each of the loosening flaps can then be folded outside downwards and removably secured together in the lower opening.

7. The animal litter collector as in claim 1, wherein the fastener is made of plastics or rubber.

8. The animal litter collector as in claim 1, wherein the receptacle is made of thick paper or cardboard paper.

9. The animal litter collector as in claim 1, wherein the receptacle is embossed with two folding lines one being an outward concave line running from the top edge of the handle portion through the lower right corner of the lower opening to the lower right corner of the blade portion and the other being an outward concave line running from the top edge of the handle portion through the lower left corner of the lower opening to the lower left corner of the blade portion.

10. The animal litter collector as in claim 1, wherein the receptacle is embossed with a middle folding line roughly separating the blade portion and the handle portion.

11. The animal litter collector as in claim 1, wherein it further comprises a bag made of paper or plastics with one side being open whose width is larger than the width of the receptacle, and the two loosening flaps can be secured together in the lower opening with the open side of the bag being secured in between.

12. The animal litter collector as in claim 11, wherein the bag has through holes near the open side and the two loosening flaps can be secured together through the through holes in the lower opening with the open side of the bag being secured in between.

13. The animal litter collector as in claim 1, wherein the bottom edge of the blade portion of the receptacle has ragged notches, teeth or points along the edge.

14. The animal litter collector as in claim 1, wherein the blade portion of the receptacle has a plurality of perforated holes.
